(19) United States
(12) Patent Application Publication
(10) Pub. No.: US 2025/0245913 A1
(43) Pub. Date: Jul. 31, 2025

(54) AUTOMATED 3D ASSET GENERATION FRAMEWORK

(71) Applicant: Walmart Apollo, LLC, Bentonville, AR (US)

(72) Inventors: Oskar Vincent Radermecker, Mountain View, CA (US); Vadivel Palaniappan, Mississauga (CA); Zhiyi Chen, North York (CA); Nima Eshraghi, Toronto (CA); Shashwat Sinha, Roseville, CA (US); Deepa Mohan, Los Altos, CA (US); Sreeneel Maddika, San Ramon, CA (US); Arami Guerra de la Llera, Frisco, TX (US)

(73) Assignee: Walmart Apollo, LLC, Bentonville, AR (US)

(21) Appl. No.: 19/041,743

(22) Filed: Jan. 30, 2025

Related U.S. Application Data
(60) Provisional application No. 63/626,625, filed on Jan. 30, 2024.

(51) Int. Cl. G06T 15/20; G06Q 30/0601; G06T 5/73; G06T 7/00; G06T 7/13; G06T 7/194; G06T 7/50; G06T 7/60; G06T 7/90; G06V 10/26; G06V 10/44; G06V 10/762; G06V 10/764; G06V 10/82

(52) U.S. Cl. CPC G06T 15/205; G06Q 30/0603; G06Q 30/0643; G06T 5/73; G06T 7/0002; G06T 7/13; G06T 7/194; G06T 7/50; G06T 7/60; G06T 7/90; G06V 10/26; G06V 10/443; G06V 10/762; G06V 10/764; G06V 10/82; G06T 2207/10024; G06T 2207/20076; G06T 2207/20081; G06T 2207/20084; G06T 2207/20192; G06T 2207/30168

(57) ABSTRACT

A system including a processor and a non-transitory computer-readable media storing computing instructions that, when executed on the processor, cause the processor to perform certain operations. The operations can include identifying a 2D silo image of a geometric item based on a probability value exceeding a predetermined probability threshold. The operations also can include segmenting artifacts from the 2D silo image to isolate first pixels of a border of the geometric item. The operations further can include trimming second pixels along the border of the geometric item. The operations also can include performing an aspect ratio validation on the 2D silo image to validate that the 2D silo image corresponds to a shape of the geometric item. The operations additionally can include auto-validating that a visual resolution level of the 2D silo image falls within a predetermined acceptance rate. The operations further can include generating a 3D view image from the 2D silo image of the geometric item enabled for use in virtual environments when the visual resolution level falls within the predetermined acceptance rate. Other embodiments are described.

### CROSS-REFERENCE TO RELATED APPLICATION

This application claims the benefit of U.S. Provisional Application No. 63/626,625, filed Jan. 30, 2024, which is incorporated herein by reference in its entirety.

### TECHNICAL FIELD

This disclosure relates generally to automated 3D asset generation framework.

### BACKGROUND

Online retailers often show 2-dimensional images of products. Customers often would like to see how products would look in their home, office, or other environment. Generating 3-dimensional (3D) assets generally involves manual creation by experienced 3-dimensional artists.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system of generating an artificial intelligence (AI) 3-dimensional (3D) pipeline to produce 3D assets from 2D images in a catalog, according to an embodiment;

FIG. 4 illustrates a flow chart for a method of generating a 3D asset from 2-dimensional (2D) images of an item, according to an embodiment;

FIG. 5 illustrates a flow chart for a method of automatically generating a 3D asset of an item, according to an embodiment;

FIG. 6 illustrates a flow chart of an activity of segmenting artifacts from the 2D silo image;

FIG. 7 illustrates a flow chart for an activity of trimming second pixels along the border of the geometric item;

FIG. 8 illustrates a flow chart for an activity of segmenting artifacts from the 2D silo image to isolate first pixels of a border of the geometric item;

FIG. 9 illustrates examples of images processed using the image segmentation model;

FIG. 10 illustrates a flow chart as a method of generating a high-resolution 2D image that can be input into the pipeline; and

FIG. 11 illustrates examples of images that are output from using the image classification model with and predicted labels with probabilities generated for each image.

### DETAILED DESCRIPTION

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 5 seconds, 10 seconds, 1 minute, 5 minutes, or another suitable time delay period.

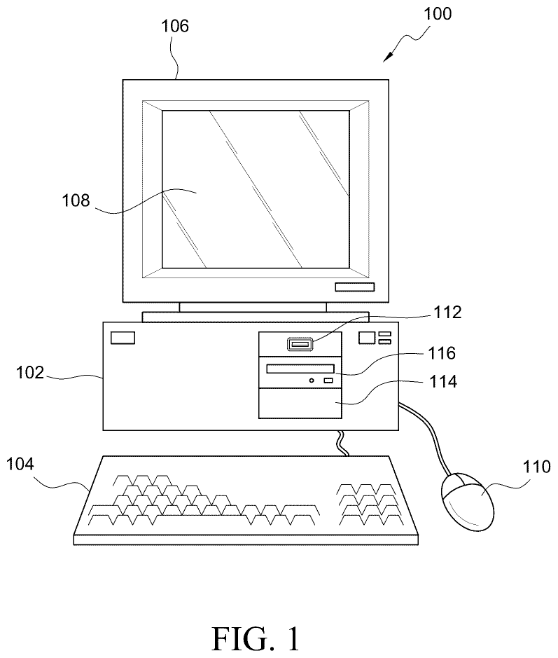

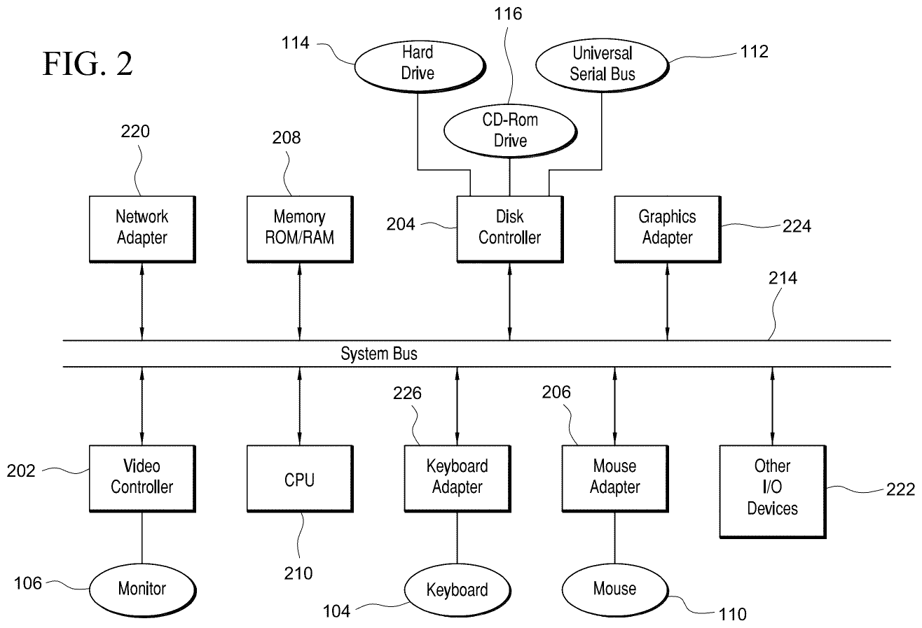

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

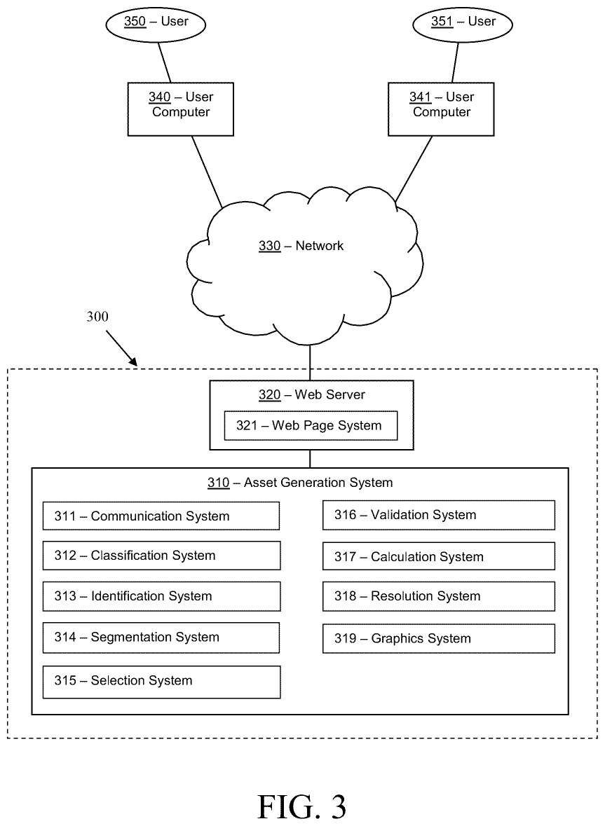

Turning ahead in the drawings, FIG. 3 illustrates a block diagram of a system 300 of generating an artificial intelligence (AI) 3-dimensional (3D) pipeline to produce 3D assets from 2D images in a catalog, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In many embodiments, system 300 can include an asset generation system 310 and/or a web server 320. Asset generation system 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or more of, or all of, asset generation system 310 and/or web server 320. Additional details regarding asset generation system 310 and/or web server 320 are described herein.

In a number of embodiments, each system of asset generation system 310 can be a special-purpose computer programed specifically to perform specific functions not associated with a general-purpose computer, as described in greater detail below.

In some embodiments, web server 320 can be in data communication through a network 330 with one or more user computers, such as user computers 340 and/or 341. Network 330 can be a public network, a private network or a hybrid network. In some embodiments, user computers 340-341 can be used by users, such as users 350 and 351, which also can be referred to as customers, in which case, user computers 340 and 341 can be referred to as customer computers. In many embodiments, web server 320 can host one or more sites (e.g., websites) that allow users to browse and/or search for items (e.g., products), to view and/or manipulate 3D items 360 degrees in a virtual space or environment (e.g., virtual try-on, augmented reality), to add items to an electronic shopping cart, and/or to order (e.g., purchase) items, in addition to other suitable activities.

In some embodiments, an internal network that is not open to the public can be used for communications between asset generation system 310 and/or web server 320 within system 300. Accordingly, in some embodiments, asset generation system 310 (and/or the software used by such systems) can refer to a back end of system 300, which can be operated by an operator and/or administrator of system 300, and web server 320 (and/or the software used by such system) can refer to a front end of system 300, and can be accessed and/or used by one or more users, such as users 350-351, using user computers 340-341, respectively. In these or other embodiments, the operator and/or administrator of system 300 can manage system 300, the processor(s) of system 300, and/or the memory storage unit(s) of system 300 using the input device(s) and/or display device(s) of system 300.

In certain embodiments, user computers 340-341 can be desktop computers, laptop computers, a mobile device, and/or other endpoint devices used by one or more users 350 and 351, respectively. A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In several embodiments, system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 300. In a similar manner, the processors and/or the non-transitory computer-readable media can be local and/or remote to each other.

Meanwhile, in many embodiments, system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, asset generation system 310 can include a communication system 311, a classification system 312, an identification system 313, a segmentation system 314, a selection system 315, a validation system 316, a calculation system 317, a resolution system 318, and/or a graphics system 319. In many embodiments, the systems of asset generation system 310 can be modules of computing instructions (e.g., software modules) stored at non-transitory computer readable media that operate on one or more processors. In other embodiments, the systems of asset generation system 310 can be implemented in hardware. Asset generation system 310 can be a computer system, such as computer system 100 (FIG. 1), as described above, and can be a single computer, a single server, or a cluster or collection of computers or servers, or a cloud of computers or servers. In another embodiment, a single computer system can host asset generation system 310. Additional details regarding asset generation system 310 and the components thereof are described herein.

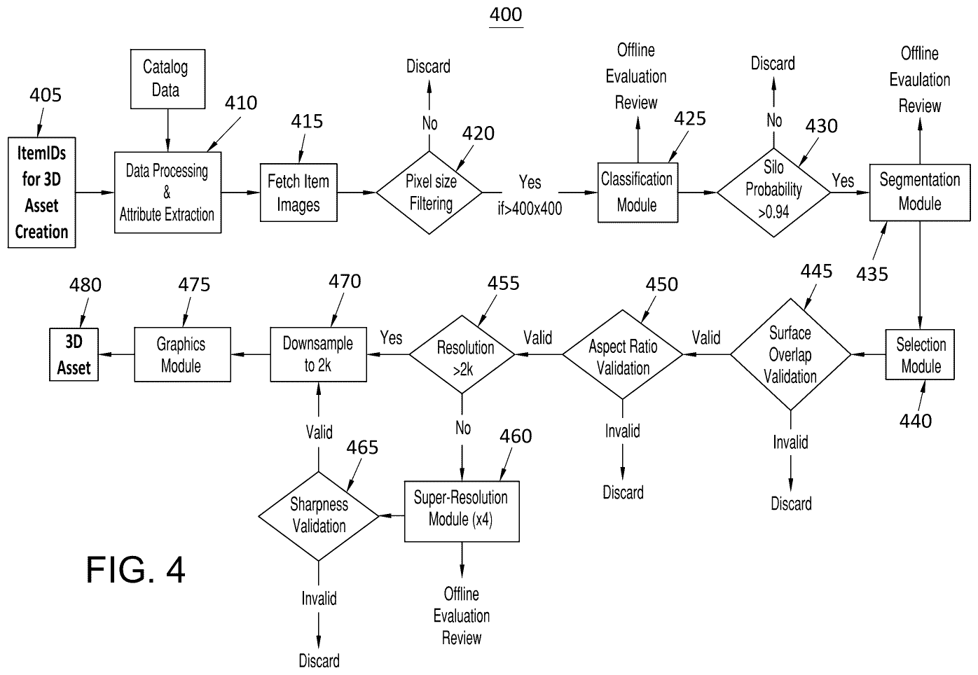

Moving ahead in the drawings, FIG. 4 illustrates a flow chart for a method 400 of generating a 3D asset from 2-dimensional (2D) images of an item. Method 400 is merely exemplary and is not limited to the embodiments presented herein. Method 400 can be employed in many different embodiments and/or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped. In several embodiments, system 300 (FIG. 3) can be suitable to perform method 400 and/or one or more of the activities of method 400.

In these or other embodiments, one or more of the activities of method 400 can be implemented as one or more computing instructions configured to run at one or more processors and configured to be stored at one or more non-transitory computer-readable media. Such non-transitory computer-readable media can be part of a computer system such as asset generation system 310 and/or web server 320. The processor(s) can be similar or identical to the processor(s) described above with respect to computer system 100 (FIG. 1).

In several embodiments, method 400 can begin with an activity 405 of obtaining an item identification (“itemIDs”) for each 3D asset creation (e.g., 3D asset) that is used as input for AI assisted 3D asset generation pipelines (e.g., flow diagrams). In various embodiments, each itemID identifying each 3D asset creation can be stored in a cache memory and/or a database. In some embodiments, an itemID can refer to data of various images, attributes, metadata, geometric shapes of the item (e.g., horizontal or vertical), and/or other suitable respective descriptors for each item as uploaded by each vendor. As an example, each vendor can upload item information and metadata using various formats, nomenclature, codes, a uniform resource location (URL), and/or another related type of descriptor for each item that is unique to that vendor. In some embodiments, each vendor of multiple vendors can use and upload unique data content that is different from that of another vendor. In many embodiments, a user can access or select a respective 3D asset (e.g., 3D view image) to load into a virtual environment for interactive viewing. In some embodiments, viewing a 3D image in an interactive virtual environment can be viewed and/or virtually manipulated in real-time. In several embodiments, the user can load more than one respective 3D asset into a virtual environment for interactive viewing. In some embodiments, a 3D asset can include a 3D graphics object that models a real-world item. Such a virtual environment can include a digital environment, an augmented reality (AR) environment, and/or another suitable artificial interactive environment loaded into an electronic device.

In a number of embodiments, method 400 can include an activity 410 of processing and extracting data from a 2D image of an item in a catalog (e.g., catalog data), such as a vendor catalog. In some embodiments, activity 410 also can include extracting visual information about the item as a 2D image. In several embodiments, an item can include a geometric item of interest based on a product with a simple geometric shape. As an example, such items with a simple geometric shape can include wall art, photo frames, a rug, and/or other suitable items with simple geometric shapes. Further, such simple geometric shapes can include shapes such as: a rectangle, an oval, a circle, a square, a triangle, and/or another suitable geometry shape of a physical good sold in a physical store and/or an online webpage.

In several embodiments, method 400 also can include an activity 415 of fetching 2D images of an item in the catalog data. In various embodiments, fetching the 2D image can include extracting image URLs. Such 2D images are configured to be used as image examples of various types of visual data representing the item. In some embodiments, multiple views of each 2D image of the item can be uploaded in the catalog. In several embodiments, each image can be classified as one of multiple classes of images of the item, such classes can include silo images, lifestyle images, two-sides images, close-up images, perspective images, multi-piece images, text images, and/or another suitable type of visual data.

In various embodiments, method 400 can include an activity 420 of determining whether or not the image size as measured in pixels of the 2D image of the item exceeds a threshold of a predetermined pixel dimension. In many embodiments, measuring (e.g., filtering) the image size can refer to a width and a height of an image in pixel dimensions and/or measurements. In various embodiments, the image size in pixels can be expressed by multiplying both the width and the height of the pixels. In some embodiments, a threshold for an image size can be expressed as whether or not the image size in pixels is greater than 400×400 pixels. If activity 420 is yes, method 400 can proceed to an activity 425. Otherwise, activity 420 is no, and method 400 can discard the 2D image of the item.

In several embodiments, method 400 can include activity 425 of classifying each extracted 2D image as a 2D silo image. In many embodiments, a 2D silo image can refer to an isolated view of an item on a background. In various embodiments, a silo image can include a white background that is made up of approximately millions of white pixels that appear as a white colored background. In some embodiments, activity 425 can be one of multiple well-integrated AI components working together as integral parts of the 3D asset generation pipeline.

In various embodiments, activity 425 of classifying each image can include using deep convolutional neural networks in which to classify images, where the neural networks are multiple layers deep. In several embodiments, such deep convolutional neural networks can include AI architectures such as ResNet 50. In some embodiments, training data for the deep convolutional neural networks to classify images can include using historical images over a time period stored in a database, where the database is continually updated with new images received from the AI architecture. The process of updating the training data for the deep convolutional neural networks allows the AI architecture to continually learn from each new iteration of images added to the training data creating a feedback loop increasing the accuracy and efficiency of the AI models of the AI architecture. Such historical images can include a database of approximately over a million images, two million images, and/or another suitable number of images.

In various embodiments, as the number of output images from the AI models increase in number, the AI model can be fine-tuned to adapt to the new data and/or tasks the updated training data which in turn allows future AI models to use the training data to train additional classification models rather than starting from scratch. In many embodiments, each 2D silo image can optionally and alternatively be subject to an offline evaluation review that can be a manual review or an automated image review.

In several embodiments, activity 425 also can include a subpart of the deep convolutional neural networks training process configured to classify 2D images that can be input in the 3D asset generation pipeline (“pipeline”).

In various embodiments, method 400 can include an activity 430 of determining whether or not an image is likely a 2D silo image rather than another class of image based on a probability score assigned to the 2D silo image that exceeds a probability threshold of a predetermined probability percentage. In various embodiments, activity 430 also can include reading an image URL of each item to identify a 2D silo image out of the multiple classes of other 2D images. If activity 430 is yes, method 400 can proceed to an activity 435. Otherwise, activity 430 is no, and method 400 can discard the 2D image of the item. In some embodiments, when the 2D image of the item is below the a probability threshold of a predetermined probability percentage, the 2D image is likely not a silo image.

In several embodiments, after identifying the 2D silo images, method 400 can include an activity 435 of preparing the 2D silo images using an image segmentation model for selection of a candidate 2D silo image that can be configured and processed into a 3D view image.

In some embodiments, method 400 can include an activity 440 of selecting candidate 2D silo images post segmentation of respective unwanted pixels and/or respective types of metadata. In several embodiments, activity 440 can include using a selection model implemented as part of this a multi-tasking process. In various embodiments, activity 440 can include selecting one candidate 2D silo image from among other candidate 2D silo images configured to be processed in the 3D asset generation pipeline.

In various embodiments, activity 440 also can include determining, using shape metadata, an incorrect shape of a candidate 2D silo image as part of sorting and selecting the candidate 2D silo image. In some embodiments, the multi-task process can begin with predicting each shape of a 2D silo image using a shape algorithm, where such shapes can include a rectangular, a circular, and other suitable shapes of simple geometry. In several embodiments, each shape of a 2D silo image can be compared to the shape of the object of interest (e.g., item) being modeled to detect potential mismatched shapes of the images being compares. In some embodiments, when a 2D silo image being compared is not a match of the shape of the item, that 2D silo image can be discarded.

In several embodiments, activity 440 also can include determining, using size metadata, an incorrect aspect ratio of a candidate 2D silo image as part of sorting and selecting the one candidate 2D silo image. In various embodiments, an aspect ratio of each remaining 2D silo image can be computed and compared against a physical aspect ratio of the item. In some embodiments, a closest match of an aspect ratio to the physical aspect ratio out of the remaining segmented 2D silo images can be retained as a potential candidate 2D silo image and moved further down the 3D asset generation pipeline. In various embodiments, in a case where multiple remaining segmented 2D silo images also have aspect ratios close enough to the physical aspect ratio within a tolerance threshold, select the 2D silo image based on a closest match to the pixel-based image size of the item as a candidate 2D silo image.

In various embodiments, method 400 can include an activity 445 of determining whether or not a selected candidate 2D silo image does not exceed a surface overlap tolerance level. If activity 445 is yes, method 400 can proceed to an activity 450. Otherwise, activity 445 is no, and the 2D silo image is deemed invalid and discarded.

In some embodiments, method 400 can include activity 450 of determining whether or not a candidate 2D silo image exceeds a threshold aspect ratio metric indicating the candidate 2D silo image is outside of an acceptable aspect ratio metric. If activity 450 is yes, method 400 can proceed to an activity 455. Otherwise, activity 450 is no, and the 2D silo image is deemed invalid and discarded.

In several embodiments, method 400 can include activity 455 of determining whether or not a candidate 2D silo image exceeds a predetermined threshold resolution indicting the candidate 2D silo image is outside of an acceptable level of image resolution, such a predetermined threshold can include a resolution metric greater than 2 k resolution. If activity 455 is yes, then method 400 can proceed to an activity 470. Otherwise, activity 455 is no, and method 400 can proceed to an activity 460.

In various embodiments, method 400 can include activity 460 of altering a resolution level of the candidate 2D silo image using a super resolution deep learning model that can sharpen a pattern and/or a texture present in the item above the predetermined threshold resolution metric. In many embodiments, super resolution deep learning can include transforming the candidate 2D silo image into a super resolved image, where the super resolved image (e.g., a super resolution image) visually appears as an improved 2D silo image able to be moved forward along the 3D asset generation pipeline. In some embodiments, each image output from the super resolution deep learning model can alternately be subject to an offline evaluation review for quality control purposes. Such an offline evaluation review can include a manual review or an automated review.

In several embodiments, method 400 can include an activity 465 of determining (e.g, confirming) whether or not the altered 2D image is validated (e.g., valid) based on a predetermined image sharpness threshold. In various embodiments, activity 465 can include using a sharpness validation quality control check based on the predetermined sharpness threshold. In some embodiments, optional activity 465 can determine when the image does not exceed the predetermined image sharpness threshold. If yes, method 400 can move forward to an activity 470. Otherwise, if no, method 400 deems the image invalid and discards the image.

In various embodiments, method 400 can include activity 470 of generating a downsampled image of the candidate 2D silo image by decreasing resolution of the image to a predetermined threshold resolution level, such as decreasing the resolution to a 2 k resolution level. In several embodiments, an advantage of implementing activity 470 can include reducing the data dimensionality of the image to increase processing speed of the image to a 3D view image. In some embodiments, decreasing the resolution to the predetermined threshold resolution can also be advantageous by (i) limiting each size of the final 3D asset and (ii) generating a standard of consistency for each 3D asset. In several embodiments, activity 470 can receive a candidate 2D silo image directly from activity 455 where the candidate 2D silo image is above 2 k resolution level and/or received an altered candidate 2D silo image from activity 465 where the image resolution level meets or exceeds the 2 k resolution level.

In various embodiments, method 400 can include an activity 475 of blending the super resolved textures of the candidate 2D silo image using attributes of the item to generate asset 480, where asset 480 can include a newly generated 3D asset of the object. In some embodiments, blending the super resolved textures can include implementing a geometry-node with controllable parameters to generate the 3D view image in the 3D asset generation pipeline. In several embodiments, activity 475 also can include using the 2 k resolution image and item metadata to create visually accurate and true-to-size 3D models (assets). Another advantage of activity 475 can include an improvement over the accuracy and resolution of the 3D models over conventional manual practices for a user to virtually try on a 3D model in a virtual space or a virtual environment.

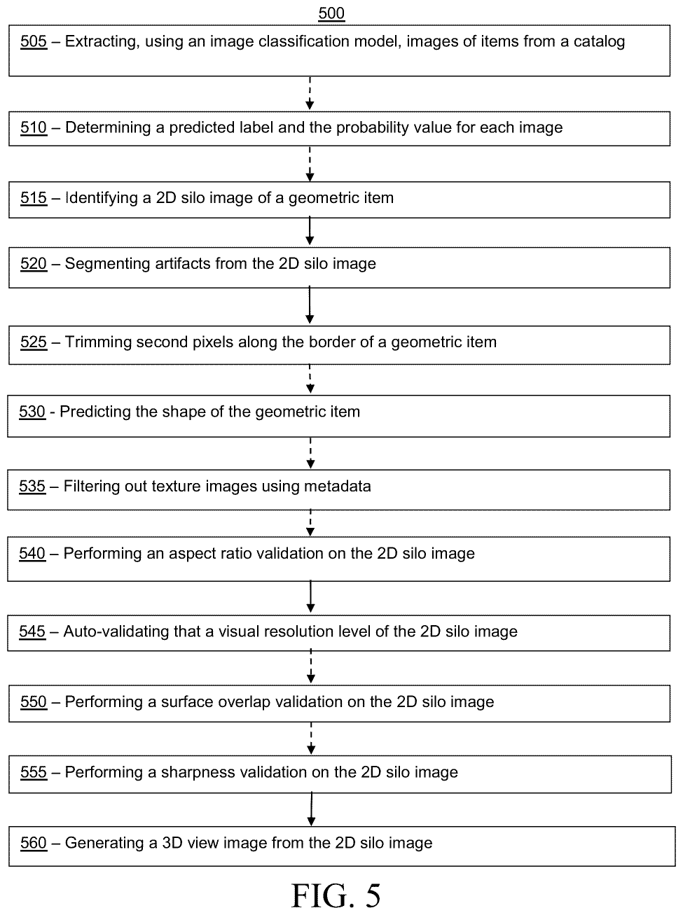

Turning ahead in the drawings, FIG. 5 illustrates a flow chart for a method 500, according to an embodiment. In some embodiments, method 500 can be a method of automatically generating a 3D asset of an item. Method 500 is merely exemplary and is not limited to the embodiments presented herein. Method 500 can be employed in many different embodiments and/or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as asset generation system 310 and/or web server 320. The processor(s) can be similar or identical to the processor(s) described above with respect to computer system 100 (FIG. 1).

Turning to the drawings, FIG. 5 can include a method 500 that can alternatively and optionally include an activity 505 of extracting, using an image classification model, images of items from a catalog into multiple classes of images. In some embodiments, activity 505 of extracting images can be similar or identical to the activities described above in connection with activities 415 and 425 (FIG. 4).

In some embodiments, method 500 also can alternatively and optionally include an activity 510 of determining a predicted label and the probability value for each image of the images. In several embodiments, activity 510 of determining a predicted label and the probability value for each image can be similar or identical to the activities described above in connection with activity 430 (FIG. 4). In various embodiments, activity 510 also can include using a classification model to fine-tune the image data.

In some embodiments, the classification model can use as input either one or multiple images from the catalog extracted during a time period. In various embodiments, the number of inputs can depend on how the classification model is trained. In some embodiments, the classification model will then output a probability distribution across all categories of interest or classes of interest. In several embodiments, all categories of interest also can be identified or labeled by using the fine-tuning process. For example, the categories of interest can include such identities or labels such as ‘close-up’, ‘lifestyle’, ‘multi-piece’, ‘perspective’, ‘silo’, ‘text’, ‘two-sides’ and/or another suitable label. As an example, using an input of an image and 7 categories or classes, the model can output 7 numbers, corresponding to each class. Further in the example, when the output of the 7 numbers sum to 1, the output can represent a probability that the input image belongs to each category of the 7 categories. In following the example, a final category can be determined by picking the most likely category with the highest probability. In some embodiments, an advantage of activity 510 can be illustrated by verifying or confirming that a maximum probability is higher than a predetermined threshold to minimize false positives, such as a threshold of approximately 95%.

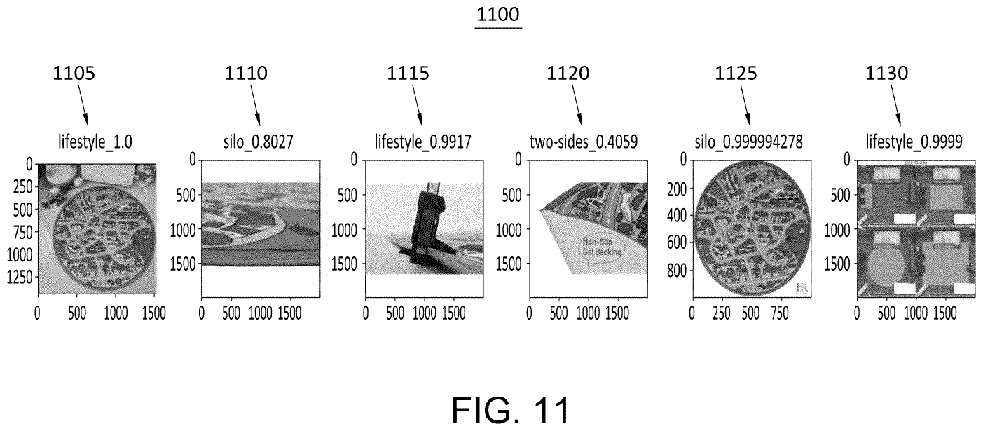

In various embodiments, when the maximum probability exceeds or meets the predetermined threshold, activity 510 also can include a predicted class of the input image. In some embodiments, when the maximum probability does not exceed the predetermined threshold, the input image can be deemed to be uncertain and to be ignored. In several embodiments, other inputs that can be used include images (i) predicted as a silo image and (ii) predicted to have a high probability of being identified as a silo image. FIG. 11 illustrates examples of images 1100 that are output from using the image classification model with and predicted labels with probabilities generated for each image. Images 1100 can include images 1105, 1110, 1115, 1120, 1125, and 1130. In the examples shown in FIG. 11, image 1110 and image 1125 are images of silo images with predicted labels. In many embodiments, image 1110 has an 80% probability that this image is a silo image where the object of interest is displayed in a background however the object of interest is not entirely displayed thus it can be discarded as a potential candidate for use in the 3D asset generation pipeline. On the other hand, image 1125 has a 99% probability that this image is a silo image where the object of interest is entirely displayed among white background pixels, thus this silo image can be deemed to be a good candidate to be processed in the 3D asset generation pipeline. In some embodiments, images 1105, 1115, 1120 and 1130 are classified as non-silo images thus, discarded from processing the images in the 3D asset generation pipeline. As an example, images 1105, 1115, and 1130 are classified as lifestyle images and image 1120 is classified as a two-side image for which these images can be classified as non-silo images. In various embodiments, examples shown in FIG. 11 can be similar or identical to the images above in connection with activity 430 (FIG. 4).

In various embodiments, method 500 can include an activity 515 of identifying a 2D silo image of a geometric item based on a probability value exceeding a predetermined probability threshold. In various embodiments, activity 515 of segmenting artifacts can be similar or identical to the activities described above in connection with activity 435 (FIG. 4).

In several embodiments, method 500 also can include an activity 520 of segmenting the object of interest from the 2D silo image by isolating first pixels of a border of the geometric item. In some embodiments, activity 520 further can include additional cleaning or removal of artifacts remaining in the 2D silo image. In many embodiments, activity 520 can also filter silo images not corresponding to the item of interest. In various embodiments, activity 520 of segmenting artifacts can be similar or identical to the activities described above in connection with activity 435 (FIG. 4).

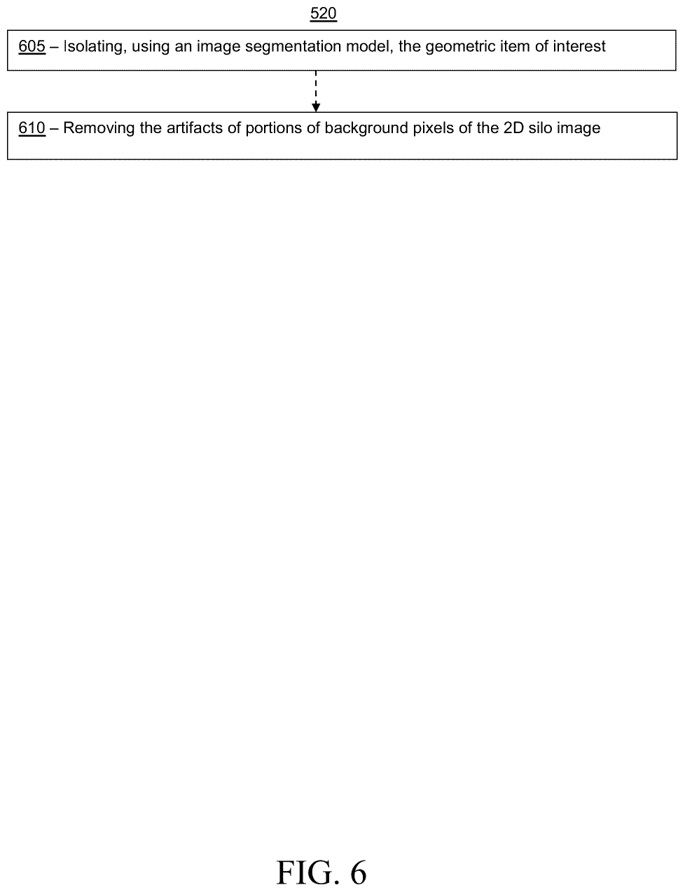

Jumping ahead in the drawings, FIG. 6 illustrates a flow chart of activity 520 (FIG. 5) of segmenting artifacts from the 2D silo image. Activity 520 can be employed in many different embodiments and/or examples not specifically depicted or described herein. In some embodiments, the procedures, the processes, and/or the activities of activity 520 can be performed in the order presented or in parallel. In other embodiments, the procedures, the processes, and/or the activities of activity 520 can be performed in any suitable order. In still other embodiments, one or more of the procedures, the processes, and/or the activities of activity 520 can be combined or skipped.

In various embodiments, activity 520 further can include an activity 605 of isolating, using an image segmentation model, the geometric item of interest in the 2D silo image without eroding edges along the 2D silo image. In several embodiments, the image segmentation model can use an AI model that can isolate pixels of an object of interest from background pixels. In various embodiments, the image segmentation model is based on using computer vision techniques to isolate pixels of the object of interest from background pixels. In some embodiments, activity 520 also can transform the 2D silo image of the object of interest into a digitally altered format enabled to be transformed into the 3D view image.

In several embodiments, when the first output contains remaining artifacts, activity 520 also can include an activity 610 of removing artifacts of background pixels of the 2D silo image using AI and computer vision techniques. In some embodiments, the portions of the background pixels can include white pixels surrounding the colored pixels of the object of interest. In many embodiments, the AI and computer vision techniques can be used to remove the unwanted pixels or the remaining isolated pixels in the 2D image by implementing such techniques as computer vision techniques and/or k-means clustering. In some embodiments, k-means clustering also can be used to find a color threshold and use this color threshold to filter out background pixels, discussed below in further detail.

In several embodiments, training data for the image segmentation model can include using historical data of images over a time period stored in a database. In some embodiments, the training data used to train the image segmentation models can be part of a feedback loop where the output of the models are input into the training data so the model learns from each iteration of new data generating probabilities with a higher accuracy metric than by using previous training data or training data sets. Conventional methods, such as semantic segmentation techniques, historically can produce sub-optimal 2D images (e.g., sub-optimum segmentations) as those conventional techniques often left background pixels that were not removed or mistakenly removed pixels where those pixels were part of the object of interest and not the background pixels. The conventional algorithms often could not remove the background pixels or removed pixels from the object of interest thus, the 2D images often appeared with fuzzy pixels or unwanted pixels appeared around the border of the segmented image of object of interest.

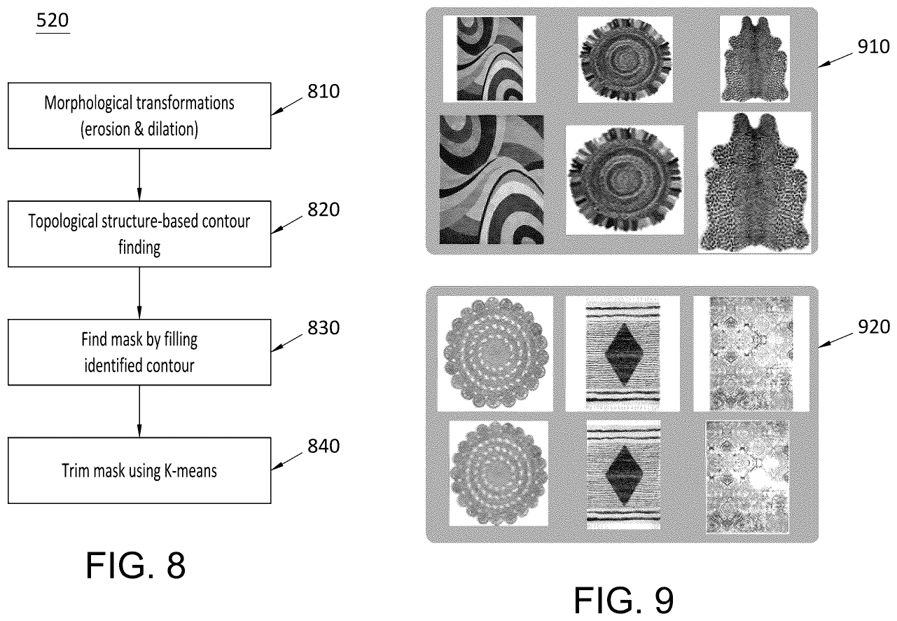

Jumping ahead in the drawings, FIG. 8 illustrates a flow chart for activity 520 of segmenting artifacts from the 2D silo image to isolate first pixels of a border of the geometric item. Activity 520 can be employed in many different embodiments and/or examples not specifically depicted or described herein. In some embodiments, the procedures, the processes, and/or the activities of activity 520 can be performed in the order presented or in parallel. In other embodiments, the procedures, the processes, and/or the activities of activity 520 can be performed in any suitable order. In still other embodiments, one or more of the procedures, the processes, and/or the activities of activity 520 can be combined or skipped.

In several embodiments, activity 520 can include an activity 810 of using morphological transformations to remove noise along any borders or edges of the object of interest in a 2D image. In some embodiments, morphological transformations can use erosion and dilation techniques to enhance a thin border to allow contour identification of the object of interest in the 2D image.

In various embodiments, activity 520 also can include an activity 820 of implementing topological structure-based contour finding to identify the contour. In several embodiments, identifying the contour of the object of interest can include capturing fine patterns or fine textures along a border or edge of the object in the 2D image.

In some embodiments, activity 520 additionally can include an activity 830 of generating a mask by filling in an identified contour on the object of interest. In several embodiments, filling in the identified contour can include using a Boolean logic to create a mask.

In various embodiments, activity 520 further can include an activity 840 of trimming the masks to remove non-object pixels. In several embodiments, activity 520 can include a runtime of less than 1 second per image. Activity 840 can be similar or identical to activity 610 (FIG. 6). FIG. 9 illustrates examples of images processed using the image segmentation model. In the examples shown in FIG. 9, images 910 are examples of accepted images after image segmentation where the white pixels were removed enough so that the image can be processed in the 3D asset generation pipeline without fuzzy boundaries and/or borders as a 3D view image. Further, images 920 are examples of rejected images that are discarded as the amount of white pixels of the object of interest remaining in the 2D image or the amount of pixels mistakenly removed of the object of interest were below an acceptable visual range to be processed as a 3D view image.

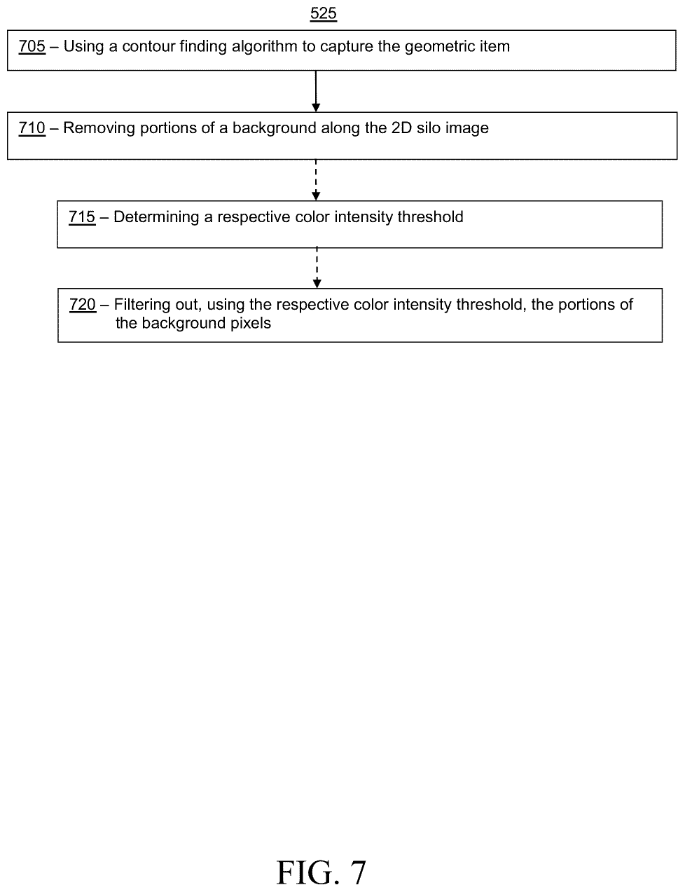

In some embodiments, method 500 further can include an activity 525 of trimming second pixels along the border of the geometric item. FIG. 7 further illustrates a flow chart for activity 525. Activity 525 can be employed in many different embodiments and/or examples not specifically depicted or described herein. In some embodiments, the procedures, the processes, and/or the activities of activity 525 can be performed in the order presented or in parallel. In other embodiments, the procedures, the processes, and/or the activities of activity 525 can be performed in any suitable order. In still other embodiments, one or more of the procedures, the processes, and/or the activities of activity 525 can be combined or skipped.

In several embodiments, activity 525 also can include an activity 705 of using a contour finding algorithm to capture the geometric item within the 2D silo image. In various embodiments, image segmentation also can include using the contour finding algorithm as part of a machine learning model to trim the borders of the segmented image to remove additional or remaining background pixels. In several embodiments, image segmentation also can use k-means to trim the boarders of the segmented image. In many embodiments, activity 705 can be similar or identical to the activities performed in activity 610 (FIG. 6).

In some embodiments, activity 525 further can include an activity 710 of removing portions of a background along the 2D silo image by separating the portions of the background into two clusters, wherein the two clusters comprise background pixels and main object pixels.

In some embodiments, image segmentation also can include using machine learning, or image processing applications for trimming pixels along the border of the 2D silo image. In many embodiments, the image segmentation can be fine-tuned using a U-Net image segmentation model that can use two convolutional layers followed by a ReLU layer for improved segmentation of the 2D silo image.

In several embodiments, activity 525 alternatively and optionally can include an activity 715 of determining a respective color intensity threshold for the 2D silo image based on the background pixels.

In various embodiments, activity 525 alternatively and optionally also can include an activity 720 of filtering out, using the respective color intensity threshold, the portions of the background pixels when the portions of the background pixels exceed the respective color intensity threshold.

Turning back to the drawings in FIG. 5, method 500 alternatively and optionally can include an activity 530 of predicting the shape of the geometric item as part of a selection process to select (e.g., find) an optimum silo image for use in the model. In some embodiments, the shape detection algorithm can include using a computer vision method that detects a geometrical shape of a binary mask of the geometric item. For example, the geometrical shape can include a circle, a square, a rectangle, and/or another suitable shape. In some embodiments, activity 530 can use an algorithm to detect the shape (or more generally, additional metadata) from the segmented silo images and filter out silo images based on their predicted shape. In various embodiments, the shape matches the shape of the item.

In several embodiments, the shape detection algorithm can count geometric measurements (e.g., measures) along rows of each segmented image. As an example, these measurements can include a length, a radius, and/or another suitable measurement. Further in this example, an exemplary length can represent a distance between a first non-white pixel and a last non-white pixel in that row of each segmented image. As another example, an exemplary radius can represent a distance between a center of the segmented image and a first non-white pixel, or the center of the segmented image and a last-non-white pixel. In various embodiments, after the shape detection algorithm counts the geometric measurements, the algorithm analyzes the gradient of the evolution of those measurements or points over the axis of the binary mark of the geometric item. In several embodiments, different shapes, such as circles or rectangles, can display widely different gradients of evolution that can be classified by respective predetermined thresholds (e.g., thresholding) for each different shape.

In some embodiments, method 500 also alternatively and optionally can include an activity 535 of aspect ratio filtering using metadata corresponding to the 2D silo image. An advantage of this invention can include creating a pipeline that can be robust when used at scale by filtering out texture images using metadata. In several embodiments, filtering out texture images using metadata can begin by fetching images from a source, such as a catalog. In some embodiments, such images that are classified as silo images are retained (e.g., not discarded). In various embodiments, another advantage of activity 535 can include filtering out a single silo image that can be used to create the 3D model as the best representation of the object from among a number of silo images identified. In many embodiments, activity 535 can use a selection algorithm that is configured to select a silo image that is most likely to represent the item of interest. As an example, if the shape is of a rectangular item, then validating on shape alone can be insufficient to identify the shape as there can be various rectangles with different aspect ratios. In following this example, selecting the closest shape reference of a rectangle among the multiple candidate silo images can be based on the aspect ratio and/or metadata.

In some embodiments, due to the network noise (e.g., noise) interfering with the content extracted from the source or the catalog, a number of silo images can still be retained after the filtering process at this stage. In several embodiments, activity 535 can reduce the number of retained silo images to one image by: (i) identifying the shape of the item in each silo image (similar or identical to the activity 530), (ii) further reducing the number of silo images by comparing each shape to the shape of the object, and (iii) calculating the aspect ratio of the object in each of the remaining silo images and comparing each aspect ratio of the object to select the aspect ratio closest to the object to select as the single silo image processed in the pipeline. In several embodiments (ii) and (iii) can include using metadata about the object itself to further reduce the number of remaining silo images to the single silo image.

In some embodiments, activity 535 can include a final optimization, such that if there are several aspect ratios that are also close to the closest aspect ratio to the object, then the final optimization selects larger silo images over smaller silo images to retain a highest possible texture quality that can be fed into the pipeline, such as exemplary asset 480 (FIG. 4). As an example, a rectangular rug of a rectangular shape of 100 inches×50 inches can include an aspect ratio of 100/50=2. In following this example, 3 rectangular silo images, identified and segmented, for the object (e.g., geometric item of interest), can include images shaped as follows: image 1 [75×13 pixels], image 2 [48×26 pixels], image 3 [250×100 pixels]. In this example, computing a respective aspect ratio for each of these segmented silo images can include the following respective aspect ratios: image 1 [75/13=5.7], image 2 [48/26=1.84], image 3 [250/100=2.5], thus in this example, out of all three examples, image 2 with an aspect ratio of 1.84 is the closest ratio to the aspect ratio of object of 2 thus, the image can be selected as the single silo image.

In several embodiments, method 500 additionally can include an activity 540 performing an aspect ratio validation on the 2D silo image to validate that the 2D silo image represents the item by analyzing aspect rations between the item and a texture of the item. In some embodiments, the single 2D silo image can include (i) the same shape as the object (e.g., rectangular), and (ii) the aspect ratio is the closest aspect ratio to the actual aspect ratio of the object among the number of silo images identified in activity 535. As an example, the aspect ratio of the object can be computed as length (inches)/width (inches). In following this example, the aspect ratio of the silo image in pixels can be computed as length (pixels)/width (pixels). Thus, in this example, both the respective metadata of the object and metadata of the segmented silo images can be used to compute these aspect ratios using respective measurements for each aspect ratio in inches and/or pixels. In some embodiments, activity 535 can illustrate that the selected single 2D silo image is based on an aspect-ratio that is closest to the real world object's aspect ratio up to a pre-determined threshold level. In several embodiments, activity 540 can include removing images that are less likely to identify or represent the item. For example, based on the aspect ratio of a candidate image, selecting the images that fall above a predetermined aspect ratio tolerance as the closest candidate image to the item.

In various embodiments, activity 540 also can include comparing an aspect ratio of each 2D silo image against a physical aspect ratio of the geometric item within a predetermined tolerance level. In some embodiments, the aspect ratio validation comprises a first quality check point that is automatically implemented. In many embodiments, calculating a physical aspect ratio of the geometric item can include using a best silo image with an aspect ratio that falls within the predetermined tolerance level. Activity 540 can be similar or identical to the activities of activity 840 (FIG. 8) of trimming the masks image is identified, the pipeline is halted to prevent poor silo image matches from being used for modeling purposes, even if that poor match is the best possible match across all candidates silo images. In some embodiments, activity 540 of performing an aspect ratio validation can be similar or identical to the activities described above in connection with activity 450 (FIG. 4).

In various embodiments, method 500 further can include an activity 545 of auto-validating a visual resolution level of the 2D silo image that exceeds a predetermined acceptance rate. In some embodiments, activity 545 checks the resolution of the 2D silo image for sufficient resolution (e.g., exceeds a predetermined acceptance rate). In several embodiments, when the 2D silo image does not exceed a predetermined acceptance rate, generating the visual resolution level further can include using a super resolution machine learning model to increase the resolution of the 2D silo image. As an example, creating a new higher resolution can include creating a larger version of an image that is too small (e.g., low resolution). In some embodiments, the super resolution machine learning model can use a Generative Adversarial Network (GAN) to generate super-resolved images. In several embodiments, the super resolution machine learning model can include RealESRGAN. In several embodiments, training data for the super resolution machine learning model can include historical data of high-resolution images and low-resolution images over a time period stored in a database. In some embodiments, the training data used to train the super resolution machine learning model can be part of a feedback loop where the output of the models are input into the training data so the model learns from each iteration of new data generating more accurate data that can be used to determine whether a 2D silo image exceeds a threshold of a resolution metric and deemed a super resolved image. In several embodiments, activity 545 of auto-validating a visual resolution level of the 2D silo image can be similar or identical to activities of 455 through 470 (FIG. 4).

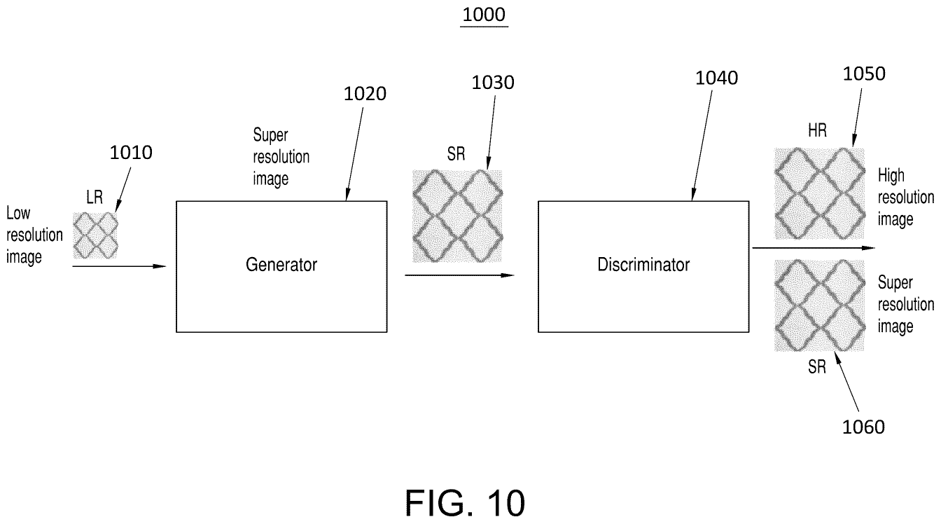

Jumping ahead in the drawings, FIG. 10 illustrates a flow chart as a method 1000 of generating a high-resolution 2D image that can be input into the pipeline. Method 1000 can begin with creating a dataset 1010 of image pairs. Such image pairs can include: a low-resolution image and a high-resolution image. In various embodiments, the low-resolution image of dataset 1010 can be processed (e.g., passed) as an input image through a generator 1020 configured to output an image 1030 of a higher resolution version of the low-resolution image. In several embodiments, discriminator model 1040 also can randomly take as input either an image 1050 of a high-resolution image or an image 1060 of a super-resolved image. In many embodiments, discriminator model 1040 also can be used for training purposes as a classifier that is configured to output a binary label for images, such as a binary label of a 0 or 1 (e.g., true/false). In some embodiments, the generator is used to learn to identify whether the input image is a real image (e.g., true) or the super-resolved image. In various embodiments, using the subpart of the deep convolutional neural networks training process can include introducing a competition between the generator and the discriminator model that can advantageously yield a higher generator performance. In several embodiments, the generator outputs the high-resolution image used in the pipeline, such as image 1050 high-resolution image or image 1060 of a super-resolution image.

In a number of embodiments, method 500 alternatively and optionally can include an activity 550 of performing a surface overlap validation on the 2D silo image to catch new artifacts forming on the 2D silo image of the geometric item. In many embodiments, the new artifacts can include deviations from shape predictions. In various embodiments, the surface overlap validation can include a second quality check point on each 2D silo image that is automatically implemented. In some embodiments, surface overlap validation can measure, validate, and/or confirm segmentation quality. As an example, when modeling a Television (TV) that has a rectangular shape, a type of mask can be generated or output by the image segmentation model. In this example, the image output is analyzed to determine whether the mask is considered as an acceptable segmentation of the 2D silo image or whether to discard this mask. In various embodiments, a mask can be a range of binary values for each image where a value of 1 represents the object of interest or at the other end of the range, a value of 0 as not representing the object of interest.

In several embodiments, a surface overlap validation can be performed by computing a reference surface measurement and comparing the reference surface measurement with the surface measurement of the mask. In some embodiments, the surface overlap can be based on a comparison of measurements for an intersection over union (IoU) metric and/or value.

In several embodiments, if an IoU value of the mask exceeds a predetermined surface overlap threshold, the mask can be used in the pipeline. Otherwise, the mask is discarded and the pipeline is halted until another mask that exceeds the predetermined surface overlap threshold is found. In several embodiments, the surface of the image can represent an expected surface of the object of interest. For example, a TV with a rectangular shape can include a mask to also be rectangular in shape. Further to the example, a reference surface can be created based on a same size and shape of the object to compare the reference surface with the mask. In various embodiments, if an image includes artifacts, the surface overlap between the reference surface and the mask can be low (e.g., closer to 0), thus the image can be flagged or discarded as not within a tolerance level of the predetermined surface overlap threshold.

In some embodiments, the AI-assisted 3D asset generation pipeline can include several automatically triggered machine learning based quality validation checks, such as the surface overlap validation quality check. An advantage of implementing multiple automatic quality validation checks can be shown (i) by a reduction in false positives and (ii) by eliminating potential 2D silo images that fall below a quality threshold of the multiple automatic quality validation checks along the 3D asset generation pipeline.

In several embodiments, the automatic surface overlap validation machine learning model can be triggered each time a segmented 2D silo image is input as part of the 3D asset generation pipeline. In some embodiments, the surface overlap validation quality check of the segmented 2D silo image can rely on assumptions about the shape of an item to detect (e.g., catch) artifacts that are beyond a tolerance level, thus deemed invalid and discarded.

In several embodiments, method 500 alternatively and optionally also can include an activity 555 of performing a sharpness validation on the 2D silo image to validate a degree of resolution of the 2D silo image, where the sharpness validation comprises a third quality check point that is automatically implemented. In various embodiments, the sharpness validation quality check can be automatically applied to each output of a super resolution model automatically triggered when the output is processed in the 3D asset generation pipeline. In several embodiments, activity 555 of performing a sharpness validation can be similar or identical to activities above in connection with activity 465 (FIG. 4).

In some embodiments, sharpness validation is based on a perceptual similarity metric and a structural similarity metric. In several embodiments, the perceptual similarity metric can be based on a learned perceptual image patch similarity (LPIPS) metric configured and designed to (i) measure a similarity between two images and/or (ii) imitate human perception of a quality metric. In various embodiments, the structural similarity metric can be based on a multi-scale structural similarity metric configured to measure a visual quality of the 2D silo image by comparing the structure of the 2D silo image at multiple scales using a reference range. In some embodiments, a measure of visual quality can include various levels of luminance, contrast, and structures. In several embodiments, a super-resolved image can pass the structural similarity check when a score above a predetermined threshold is higher when compared to a low-resolution counterpart.

In many embodiments, method 500 further can include an activity 560 of generating a 3D view image from the 2D silo image of the geometric item enabled for use in virtual environments when the visual resolution level falls within the predetermined acceptance rate. In several embodiments, activity 560 of generating a 3D view image from the 2D silo image can be similar or identical to activities above in connection with activity 475 (FIG. 4).

Returning to FIG. 3, communication system 311 can at least partially perform activity 410 (FIG. 4) of processing and extracting data from a 2D image of an item in a catalog (e.g., catalog data), such as a vendor catalog, and/or activity 420 (FIG. 4) of determining whether or not the image size measured in pixels of the 2D image of the item exceeds a threshold of a predetermined pixel dimension.

In many embodiments, classification system 312 can at least partially perform, activity 425 (FIG. 4) of classifying each extracted 2D image as a 2D silo image, and/or activity 430 (FIG. 4) of determining whether or not an image is likely a 2D silo image rather than another class of image based on a probability score assigned to the 2D silo image that exceeds a probability threshold of a predetermined probability percentage, extracting, using an image classification model, images of items from a catalog into multiple classes of images.

In some embodiments, identification system 313 can at least partially perform activity 405 (FIG. 4) of obtaining an item identification (“itemIDs”) for each 3D asset creation (e.g., 3D asset) that is used as input for AI assisted 3D asset generation pipelines (e.g., flow diagrams), activity 415 (FIG. 4) of fetching 2D images of an item in the catalog data, and/or activity 515 (FIG. 5) of identifying a 2D silo image of a geometric item based on a probability value exceeding a predetermined probability threshold.

In several embodiments, segmentation system 314 can at least partially perform activity 435 (FIG. 4) of preparing the 2D silo images using an image segmentation model for selection of a candidate 2D silo image that can be configured and processed into a 3D view image, activity 520 (FIG. 5) of segmenting artifacts from the 2D silo image, activity 525 (FIG. 5) of trimming second pixels along the border of the geometric item, activity 605 (FIG. 6) of isolating, using an image segmentation model, the geometric item of interest in the 2D silo image without eroding edges along the 2D silo image, activity 610 (FIG. 6) of removing artifacts of background pixels of the 2D silo image, activity 810 (FIG. 8) of using morphological transformations to remove noise along any borders or edges of the object of interest in a 2D image, activity 820 (FIG. 8) of implementing topological structure-based contour finding to identify the contour, activity 830 (FIG. 8) of generating a mask by filling in an identified contour on the object of interest, activity 840 (FIG. 8) of trimming the masks to remove non-object pixels, activity 715 (FIG. 7) of determining a respective color intensity threshold for the 2D silo image based on the background pixels, and/or activity 720 (FIG. 7) of filtering out, using the respective color intensity threshold, the portions of the background pixels when the portions of the background pixels exceed the respective color intensity threshold.

In a number of embodiments, selection system 315 can at least partially perform activity 440 (FIG. 4) of selecting candidate 2D silo images post segmentation of respective unwanted pixels and/or respective types of metadata.

In various embodiments, validation system 316 can at least partially perform activity 445 (FIG. 4) of determining whether or not a selected candidate 2D silo image does not exceed a surface overlap tolerance level, activity 450 (FIG. 4) of determining whether or not a candidate 2D silo image exceeds a threshold aspect ratio metric indicating the candidate 2D silo image is outside of an acceptable aspect ratio metric, activity 455 (FIG. 4) of determining whether or not a candidate 2D silo image exceeds a predetermined threshold resolution indicting the candidate 2D silo image is outside of an acceptable level of image resolution, such a predetermined threshold can include a resolution metric greater than 2 k resolution, activity 550 (FIG. 5) of auto-validating a visual resolution level of the 2D silo image that exceeds a predetermined acceptance rate, an activity 550 (FIG. 5) of performing a surface overlap validation on the 2D silo image to catch new artifacts forming on the 2D silo image of the geometric item, and/or activity 555 (FIG. 5) of performing a sharpness validation on the 2D silo image to validate a degree of resolution of the 2D silo image, where the sharpness validation comprises a third quality check point that is automatically implemented.

In some embodiments, calculation system 317 can at least partially perform activity 510 (FIG. 5) of determining a predicted label and the probability value for each image of the images, activity 705 (FIG. 7) of using a contour finding algorithm to capture the geometric item within the 2D silo image, activity 710 (FIG. 7) of removing portions of a background along the 2D silo image by separating the portions of the background into two clusters, wherein the two clusters comprise background pixels and main object pixels, activity 530 (FIG. 5) of predicting the shape of the geometric item by computing the aspect ratio of each portion of the 2D silo image, activity 535 (FIG. 5) of filtering out texture images using metadata corresponding to the 2D silo image, and/or activity 540 (FIG. 5) of performing an aspect ratio validation on the 2D silo image to validate that the 2D silo image corresponds to a shape of the geometric item.

In several embodiments, resolution system 318 can at least partially perform activity 460 (FIG. 4) of altering a resolution level of the candidate 2D silo image using a super resolution deep learning model that can sharpen a pattern and/or a texture present in the item above the predetermined threshold resolution metric, activity 465 (FIG. 4) of determining (e.g., confirming) whether or not to validate the altered 2D image based on a predetermined image sharpness threshold, and/or activity 470 (FIG. 4) of generating a downsampled image of the candidate 2D silo image by decreasing resolution of the image to a predetermined threshold resolution level, such as decreasing the resolution to a 2 k resolution level.

In many embodiments, graphics system 319 can at least partially perform activity 475 (FIG. 4) of blending the super resolved textures of the candidate 2D silo image using attributes of the item to generate asset 480 (FIG. 4), where asset 480 (FIG. 4) can be the newly generated 3D view image.

In several embodiments, web server 320 can include a web page system 321. Web page system 321 can at least partially perform sending instructions to user computers (e.g., 350-351 (FIG. 3)) based on information received from communication system 311.

In many embodiments, the techniques described herein can be used continuously enable the automatic creation of 3D view images at a scale that cannot be handled using manual techniques. Conventionally, generating assets at scale can be expensive and time consuming using manual quality checks. The techniques of automated machine learning using component validation can be advantageous as using the component-level and pipeline-level auto-validation approaches can reduce false positives and discard invalid images. For example, the number of daily and/or monthly visits to the content source can exceed approximately ten million and/or other suitable numbers, the number of registered users to the content source can exceed approximately one million and/or other suitable numbers, and/or the number of products and/or items sold on the website can exceed approximately ten million (10,000,000) approximately each day.

In a number of embodiments, the techniques described herein can solve a technical problem that arises only within the realm of computer networks, as determining whether to process a 2D image uploaded into a catalog into a 3D view image does not exist outside the realm of computer networks. Such techniques that can solve technical problems can include using enhanced border quality for semantic segmentation, improved super-resolution auto-validation using perceptual and structural similarity, and improved asset quality using texture wrapping and dynamic texture coloring. Moreover, the techniques described herein can solve a technical problem that cannot be solved outside the context of computer networks. Specifically, the techniques described herein cannot be used outside the context of computer networks, in view of a lack of data, and because a content catalog, such as an online catalog, that can power and/or feed an online website that is part of the techniques described herein would not exist.

Various embodiments can include a system including a processor and a non-transitory computer-readable media storing computing instructions that, when executed on the processor, cause the processor to perform certain operations. The operations can include identifying a 2D silo image of a geometric item based on a probability value exceeding a predetermined probability threshold. The operations also can include segmenting artifacts from the 2D silo image to isolate first pixels of a border of the geometric item. The operations further can include trimming second pixels along the border of the geometric item. The operations also can include performing an aspect ratio validation on the 2D silo image to validate that the 2D silo image corresponds to a shape of the geometric item. The operations additionally can include auto-validating that a visual resolution level of the 2D silo image falls within a predetermined acceptance rate. The operations further can include generating a 3D view image from the 2D silo image of the geometric item enabled for use in virtual environments when the visual resolution level falls within the predetermined acceptance rate.

A number of embodiments can include a computer-implemented method. The method can include identifying a 2D silo image of a geometric item based on a probability value exceeding a predetermined probability threshold. The method also can include segmenting artifacts from the 2D silo image to isolate first pixels of a border of the geometric item. The method further can include trimming second pixels along the border of the geometric item. The method also can include performing an aspect ratio validation on the 2D silo image to validate that the 2D silo image corresponds to a shape of the geometric item. The method additionally can include auto-validating that a visual resolution level of the 2D silo image falls within a predetermined acceptance rate. The method further can include generating a 3D view image from the 2D silo image of the geometric item enabled for use in virtual environments when the visual resolution level falls within the predetermined acceptance rate.

Additional embodiments can include a non-transitory computer-readable media storing computing instructions that, when executed on a processor, cause the processor to perform certain operations. The operations can include identifying a 2D silo image of a geometric item based on a probability value exceeding a predetermined probability threshold. The operations also can include segmenting artifacts from the 2D silo image to isolate first pixels of a border of the geometric item. The operations further can include trimming second pixels along the border of the geometric item. The operations also can include performing an aspect ratio validation on the 2D silo image to validate that the 2D silo image corresponds to a shape of the geometric item. The operations additionally can include auto-validating that a visual resolution level of the 2D silo image falls within a predetermined acceptance rate. The operations further can include generating a 3D view image from the 2D silo image of the geometric item enabled for use in virtual environments when the visual resolution level falls within the predetermined acceptance rate.

Although automatically transforming a 2D image into a 3D view image for use in an interactive virtual environment has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 3, 4-7 may include different procedures, processes, and/or activities and be performed by many different modules, in many different orders, and/or one or more of the procedures, processes, or activities of FIGS. 3, 4-7 may include one or more of the procedures, processes, or activities of another different one of FIGS. 3, 4-7. As another example, the systems within communication system 311, classification system 312, identification system 313, segmentation 314, selection system 315, validation system 316, calculation system 317, resolution system 318, graphics system 319, web server 320 and/or web page system catalog 321. Additional details regarding communication system 311, classification system 312, identification system 313, segmentation 314, selection system 315, validation system 316, calculation system 317, resolution system 318, graphics system 319, web server 320 and/or web page system catalog 321, (see FIGS. 3 and 7) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising a processor and a non-transitory computer-readable medium storing computing instructions that, when executed on the processor, cause the processor to perform operations comprising:
identifying a 2D silo image of a geometric item based on a probability value exceeding a predetermined probability threshold;
segmenting artifacts from the 2D silo image to isolate first pixels of a border of the geometric item;
trimming second pixels along the border of the geometric item;
performing an aspect ratio validation on the 2D silo image to validate that the 2D silo image corresponds to a shape of the geometric item;
auto-validating that a visual resolution level of the 2D silo image falls within a predetermined acceptance rate; and
generating a 3D view image from the 2D silo image of the geometric item enabled for use in virtual environments when the visual resolution level falls within the predetermined acceptance rate.

2. The system of claim 1, wherein the operations further comprise:
extracting, using an image classification model, images of items from a catalog into multiple classes of images; and
determining a predicted label and the probability value for each image of the images.

3. The system of claim 1, wherein segmenting the artifacts from the 2D silo image comprises:
isolating, using an image segmentation model, the geometric item of interest in the 2D silo image without eroding edges along the 2D silo image.

4. The system of claim 3, wherein segmenting the artifacts from the 2D silo image further comprises:
removing the artifacts of portions of background pixels of the 2D silo image, wherein the portions of the background pixels comprise white pixels.

5. The system of claim 1, wherein trimming the second pixels along the border of the geometric item comprises:
using a contour finding algorithm to capture the geometric item within the 2D silo image; and
removing portions of a background along the 2D silo image by separating the portions of the background into two clusters, wherein the two clusters comprise background pixels and main object pixels.

6. The system of claim 5, wherein removing portions of the background along the 2D silo image further comprises:
determining a respective color intensity threshold for the 2D silo image based on the background pixels; and
filtering out, using the respective color intensity threshold, the portions of the background pixels when the portions of the background pixels exceed the respective color intensity threshold.

7. The system of claim 1, wherein performing the aspect ratio validation on the 2D silo image comprises:
comparing an aspect ratio of each 2D silo image against a physical aspect ratio of the geometric item within a predetermined tolerance level, wherein the aspect ratio validation comprises a first quality check point that is automatically implemented.

8. The system of claim 1, wherein the operations further comprise:
predicting the shape of the geometric item by computing the aspect ratio of each portion of the 2D silo image; and
filtering out texture images using metadata corresponding to the 2D silo image.

9. The system of claim 1, wherein the operations further comprise:
performing a surface overlap validation on the 2D silo image to catch new artifacts forming on the 2D silo image of the geometric item, wherein the new artifacts comprise deviations from shape predictions, and wherein the surface overlap validation comprises a second quality check point on each 2D silo image that is automatically implemented; and
performing a sharpness validation on the 2D silo image to validate a degree of resolution of the 2D silo image, where the sharpness validation comprises a third quality check point that is automatically implemented.

10. The system of claim 9, wherein the sharpness validation is based on a perceptual similarity metric and a structural similarity metric.

11. A computer-implemented method comprising:
identifying a 2D silo image of a geometric item based on a probability value exceeding a predetermined probability threshold;
segmenting artifacts from the 2D silo image to isolate first pixels of a border of the geometric item;
trimming second pixels along the border of the geometric item;
performing an aspect ratio validation on the 2D silo image to validate that the 2D silo image corresponds to a shape of the geometric item;
auto-validating that a visual resolution level of the 2D silo image falls within a predetermined acceptance rate; and
generating a 3D view image from the 2D silo image of the geometric item enabled for use in virtual environments when the visual resolution level falls within the predetermined acceptance rate.

12. The computer-implemented method of claim 11 further comprising:
extracting, using an image classification model, images of items from a catalog into multiple classes of images; and
determining a predicted label and the probability value for each image of the images.

13. The computer-implemented method of claim 11, wherein segmenting the artifacts from the 2D silo image comprises:
isolating, using an image segmentation model, the geometric item of interest in the 2D silo image without eroding edges along the 2D silo image.

14. The computer-implemented method of claim 13, wherein segmenting the artifacts from the 2D silo image further comprises:
removing the artifacts of portions of background pixels of the 2D silo image, wherein the portions of the background pixels comprise white pixels.

15. The computer-implemented method of claim 11, wherein trimming the second pixels along the border of the geometric item comprises:
using a contour finding algorithm to capture the geometric item within the 2D silo image; and
removing portions of a background along the 2D silo image by separating the portions of the background into two clusters, wherein the two clusters comprise background pixels and main object pixels.

16. The computer-implemented method of claim 15, wherein removing portions of the background along the 2D silo image further comprises:
determining a respective color intensity threshold for the 2D silo image based on the background pixels; and
filtering out, using the respective color intensity threshold, the portions of the background pixels when the portions of the background pixels exceed the respective color intensity threshold.

17. The computer-implemented method of claim 11, wherein performing the aspect ratio validation on the 2D silo image comprises:
comparing an aspect ratio of each 2D silo image against a physical aspect ratio of the geometric item within a predetermined tolerance level, wherein the aspect ratio validation comprises a first quality check point that is automatically implemented.

18. The computer-implemented method of claim 11 further comprising:
predicting the shape of the geometric item by computing the aspect ratio of each portion of the 2D silo image; and
filtering out texture images using metadata corresponding to the 2D silo image.

19. A non-transitory computer-readable medium storing computing instructions that, when executed on a processor, cause the processor to perform operations comprising:
identifying a 2D silo image of a geometric item based on a probability value exceeding a predetermined probability threshold;
segmenting artifacts from the 2D silo image to isolate first pixels of a border of the geometric item;
trimming second pixels along the border of the geometric item;
performing an aspect ratio validation on the 2D silo image to validate that the 2D silo image corresponds to a shape of the geometric item;
auto-validating that a visual resolution level of the 2D silo image falls within a predetermined acceptance rate; and
generating a 3D view image from the 2D silo image of the geometric item enabled for use in virtual environments when the visual resolution level falls within the predetermined acceptance rate.

20. The non-transitory computer-readable medium of claim 19, wherein the operations further comprise:
extracting, using an image classification model, images of items from a catalog into multiple classes of images; and
determining a predicted label and the probability value for each image of the images.
